(19) United States
(12) Patent Application Publication
(10) Pub. No.: US 2025/0206932 A1
(43) Pub. Date: Jun. 26, 2025

(54) LIVING HINGE OF AN ALPHA-NUCLEATED PROPYLENE COPOLYMER

(71) Applicant: BOREALIS AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Dieter Nicolussi, Linz (AT)

(21) Appl. No.: 18/847,290

(22) PCT Filed: Mar. 21, 2023
(86) PCT No.: PCT/EP2023/057178

§ 371 Date: Sep. 16, 2024

(30) Foreign Application Priority Data
Mar. 23, 2022 (EP) 22 163 881.0

(51) Int. Cl. C08L 23/14; B29C 45/00; B29K 23/00; B29L 31/22

(52) U.S. Cl. CPC C08L 23/142; B29C 45/0001; B29C 45/0017; B29K 2023/14; B29L 2031/22; C08L 2205/025; C08L 2205/24

(57) ABSTRACT

Living hinge consisting of a polypropylene composition comprising as main component a propylene copolymer having comonomer content in the range of 2.0 to 6.5 mol-% and an alpha-nucleating agent.

The present invention is directed to a living hinge consisting of a polypropylene composition comprising at least 95.0 wt.-% of a propylene copolymer and 0.1 to 1.0 wt.-% of an alpha-nucleating agent, as well as to injection molded articles comprising two rigid pieces which are connected with at least one living hinge.

A living hinge is a thin, flexible hinge connecting two relatively rigid parts. Typically, it is made from the same material as the rigid parts. It is especially preferred that the living hinge and the rigid parts are one piece, i.e. produced in one process, typically by injection molding. The living hinge may be used to join rigid parts of a container, allowing them to bend along the line of the hinge. Polypropylene has an especially good reputation for the use as living hinges, where its combination of stiffness and flexibility allows hundreds of cycles without breakage. Accordingly living hinges are an integral part of modern packaging systems, like in sports-drink or cosmetics closures, but also in longer lasting articles like household or hiking equipment. Regarding such packaging systems there is the need to balance hinge performance (especially flexibility) with stiffness, transparency and solubles content. There is, consequently, still a need for a next generation of materials with an improved property balance.

The finding of the present invention is to provide a living hinge consisting of a polypropylene composition which comprises as main component a propylene copolymer (at least 95.0 wt.-% of the polypropylene composition) and 0.01 to 1.0 wt.-% of an alpha-nucleating agent, wherein said propylene copolymer has been produced in the presence of a metallocene catalyst and therefore has 2, 1 erythro regio-defects in the range of >0.35 to 0.85 mol-%, measured by ¹³C NMR and the comonomer of the propylene copolymer is a higher alpha-alkene, i.e. 1-butene, 1-hexene or 1-octene.

Accordingly, the present invention is directed to
a living hinge consisting of a polypropylene composition comprising
   (a) at least 95.0 wt.-%, preferably at least 97.0 wt.-%, based on the total weight of the polypropylene composition, of a propylene copolymer, said propylene copolymer has a comonomer selected from the group consisting of 1-butene, 1-hexene and 1-octene, preferably said propylene copolymer is a 1-butene-propylene copolymer, and
   (b) 0.01 to 1.0 wt.-%, preferably 0.05 to 0.5 wt.-%, based on the total weight of the polypropylene composition, of an alpha-nucleating agent,
wherein further the polypropylene composition has
   (ii) a comonomer content, measured by ¹³C-NMR, is in the range of 2.0 to 6.5 mol-%, the comonomer is selected from the group consisting of 1-butene, 1-hexene and 1-octene, preferably the comonomer is 1-butene,
   (iii) 2, 1 erythro regio-defects, measured by ¹³C NMR, in the range of >0.35 to 0.85 mol-% and
   (iv) a melt flow rate MFR₂ (230° C.; 2.16 kg), measured according to ISO 1133, in the range of 15 to 100 g/10 min.

Preferred embodiments of the polypropylene composition from which the living hinge is produced is defined in the dependent claims to claim 1.

The invention is further directed to an injection molded article, preferably a thin wall injection molded article having a wall thickness up to 2.00 mm, comprising two rigid pieces which are connected by at least one living hinge, wherein
the injection molded article consists of the polypropylene composition as defined in any one of the claims 1 to 11 and
the injection molded article is made as a single piece.

The present invention is further directed to an injection molded article as defined in the previous paragraph, wherein the two rigid pieces are compartments which are connected by the at least one living hinge, preferably said injection molded article is a storage box.

The present invention is further directed to an injection molded article comprising two rigid pieces which are connected by at least one living hinge, wherein the injection molded article consists of the polypropylene composition as defined in any one of the claims 1 to 9 and
the injection molded article is made as a single piece
wherein further
the injection molded article is a hinge cap, wherein one rigid piece is the cap and the other rigid piece is the mount.

Finally the present invention is directed the use of the polypropylene composition as defined in any one of the claims 1 to 9 for the manufacture of a living hinge or an injection molded article including at least one living hinge, wherein preferably the injection molded article is a thin wall injection molded article having a wall thickness up to 2.00 mm, preferably having a wall thickness in the range of 0.05 to 2.00 mm. Preferably the living hinge is an injection molded living hinge, i.e. obtained by injection molding the polypropylene composition as defined in any one of the claims 1 to 9. Preferably the polypropylene composition as defined in any one of the claims 1 to 9 is used for the manufacture of an injection molded article including at least one living hinge, wherein said injection molded article is one piece.

In the following, the invention is defined in more detail.

### Living Hinge/Injection Molded Article

The living hinge according to this invention is understood as by a skilled person, i.e. as a thin, flexible hinge typically connecting two relatively rigid parts. The living hinge according to this invention is preferably made by injection molding. It is further preferred that the thickness of the living hinge is considerable thinner than the rigid parts which are typically connected by the living hinge. Accordingly the living hinge has preferably a thickness in the range of 0.05 to 0.50 mm, more preferably in the range of 0.08 to 0.40 mm, like in the range of 0.10 to 0.35 mm.

Further, the living hinge according to this invention consists of the polypropylene composition as defined in more detail below. That is, the living hinge is made from the polypropylene composition as defined in more detail below. In a preferred embodiment, the living hinge is made by injection molding, more preferably by thin wall injection molding, from the polypropylene composition as defined in more detail below. The techniques of injection molding and thin wall injection molding in the field of polypropylene is known by the skilled person. Reference is made for instance to the “Polypropylene Handbook” of Nello Pasquini, 2^{nd} edition (pages 422 to 442).

Still more preferably, the invention is directed to an injection molded article comprising two rigid pieces which are connected by at least one living hinge, wherein
the injection molded article consists of the polypropylene composition as defined in more detail below and
the injection molded article is made as a single piece.

That is, the injection molded article in which the two rigid pieces are connected with at least one living hinge is made in one process, i.e. is one single piece, from the polypropylene composition as defined in more detail below.

Preferably, the injection molding process is a thin wall injection molding process and thus the wall thickness of the injection molded article is less than 2.00 mm, preferably in the range of 0.7 to 1.7 mm, more preferably in the range of 0.9 to 1.6 mm. Accordingly it is preferred that the two rigid pieces have a wall thickness in the range of 0.60 to 2.00 mm, more preferably in the range of 0.7 to 1.7 mm, still more preferably in the range of 0.9 to 1.6 mm, and the at least one living hinge has preferably a wall thickness in the range of 0.05 to 0.50 mm.

Preferably the injection molded article, still more preferably the thin wall injection molded article, made from the polypropylene composition as defined in more detail below comprises two compartments which are connected by the at least one living hinge. One specific example of such an injection molded article is a storage box.

In another preferred embodiment the injection molded article comprising two rigid pieces which are connected by at least one living hinge, wherein
the injection molded article consists of the polypropylene composition as defined in more detail below and
the injection molded article is made as a single piece,
is hinge cap, wherein one rigid piece is the cap and the other rigid piece is the mount.

In still another preferred embodiment the present invention is directed to the use of the polypropylene composition as defined below for the manufacture of a living hinge or an injection molded article including at least one living hinge, wherein preferably the injection molded article is a thin wall injection molded article having a wall thickness up to 2.00 mm, preferably in the range of 0.7 to 1.7 mm, more preferably in the range of 0.9 to 1.6 mm. The preferred embodiments which are manufactured by the use of the polypropylene composition according to this invention are defined above.

### The Polypropylene Composition

The living hinge and the injection molded articles comprising said living hinge are made from the polypropylene composition as defined in the following. First the individual components of the polypropylene composition are described and subsequently the polypropylene composition as such.

### The Propylene Copolymer

The by far major part of the polypropylene composition is a propylene copolymer, i.e. at least 95.0 wt.-%, more preferably at least 97.0 wt.-%, of the polypropylene composition is the propylene copolymer.

The comonomer of the propylene copolymer is selected from the group consisting of 1-butene, 1-hexene and 1-octene. More preferably, the propylene copolymer is a 1-butene-propylene copolymer. Preferably said propylene copolymer has a comonomer content in the range of 2.0 to 6.5 mol-%, preferably in the range of 3.0 to 5.5 mol-%, measured by ¹³C-NMR. Thus it is especially preferred the propylene copolymer is a 1-butene-propylene copolymer having a 1-butene content in the range of 2.0 to 6.5 mol-%, preferably in the range of 3.0 to 5.5 mol-%, measured by ¹³C-NMR.

Further the propylene copolymer according to this invention must be produced with a metallocene catalyst, which is reflected by the presence of 2, 1 erythro regio-defects in the polymer chain. Further information regarding the polymerisation conditions is provided in detail below. Accordingly, it is preferred that propylene copolymer according to this invention has 2,1 erythro regio-defects, measured by ¹³C NMR, in the range of >0.35 to 0.85 mol-%, more preferably in the range of 0.4 to 0.75 mol-%.

A further characteristic of the propylene copolymer, due to its manufacture with a metallocene catalyst, is its rather low amounts of xylene cold solubles. Thus it is preferred that the propylene copolymer has a xylene cold soluble (XCS) fraction, determined at 25° C. according to ISO 16152, in the range of 0.1 to 1.0 wt.-%, more preferably in the range of 0.2 to 0.6 wt.-%. A low soluble content is also an indicator that the propylene copolymer is not a heterophasic system but is monophasic. In other words, the propylene copolymer does not comprise polymer components, which are not miscible with each other, as this is the case for heterophasic propylene copolymers. In contrast to monophasic systems, heterophasic systems comprise a continuous polymer phase, like a polypropylene, in which a further non-miscible polymer, like an elastomeric polymer, is dispersed as inclusions. Said polypropylene systems containing a polypropylene matrix and inclusions as a second polymer phase would by contrast be called heterophasic and are not part of the present invention. The presence of second polymer phases or the so-called inclusions is for instance visible by high resolution microscopy, like electron microscopy or atomic force microscopy, or by dynamic mechanical thermal analysis (DMTA). Specifically in DMTA, the presence of a multiphase structure can be identified by the presence of at least two distinct glass transition temperatures.

Further it is preferred that the propylene copolymer has a molecular weight distribution (MWD), defined as the ratio between the weight average molecular weight (Mw) and the number average molecular weight (Mn) and determined by Gel Permeation Chromatography (GPC) in the range of 2.0 to 5.0, more preferably in the range of 2.1 to 4.5, still more preferably in the range of 2.2 to 3.5.

Additionally the molecular weight of the propylene copolymer must be low enough that a living hinge and the injection moulded article, preferably the thin wall injection moulded article, can be produced. Hence it is preferred that the propylene copolymer has a melt flow rate MFR₂ (230° C.; 2.16 kg), measured according to ISO 1133, in the range of 15 to 100 g/10 min, more preferably in the range of 16 to 90 g/10 min, still more preferably in the range of 17 to 80 g/10 min.

In a preferred embodiment, the propylene copolymer comprises two propylene copolymer fractions. That is, the propylene copolymer comprises
(a) a first propylene copolymer fraction (F1) having a comonomer content, measured by ¹³C-NMR, is in the range of 2.0 to 6.5 mol-%, preferably in the range of 2.5 to 5.0 mol-%, measured by ¹³C-NMR, and
(b) a second propylene copolymer fraction (F2),
wherein
   the comonomer for the first propylene copolymer fraction (F1) and the second propylene copolymer (F2) is the same, but the amount of comonomer in the first propylene copolymer (F1) and second propylene copolymer (F2) is different;
   the weight ratio between the first propylene copolymer fraction (F1) and the second propylene copolymer fraction (F2) [(F1)/(F2)] is in the range of 60/40 to 40/60, and
   the total amount of the first propylene copolymer fraction (F1) and the second propylene copolymer fraction (F2) together, based on the propylene copolymer, is at least 98 wt.-%, preferably the propylene copolymer consists, of the first propylene copolymer fraction (F1) and the second propylene copolymer fraction (F2).

Still more preferably the propylene copolymer complies with the equation 2, yet more preferably with the equation 2a,

$$\frac{C ( PPC )}{( C ( F 1 ) \times [ ( F 1 ) / ( PPC ) ] )} > 2.5 \qquad ( 2 )$$

$$3.5 > \frac{C ( PPC )}{( C ( F 1 ) \times [ ( F 1 ) / ( PPC ) ] )} > 2.5 \qquad ( 2 a )$$

wherein
“C(PPC)” is the comonomer content [mol-%], measured by ¹³C NMR, of the propylene copolymer;
“C(F1)” is the comonomer content [mol-%], measured by ¹³C NMR, of the first propylene copolymer fraction (F1);
“(F1)/(PPC)” is the amount of the first propylene copolymer fraction (F1) in the propylene copolymer divided by the amount of the propylene copolymer.

Accordingly it is further preferred that the comonomer content between the first propylene copolymer fraction (F1) and the second propylene copolymer fraction (F2) differs in the range of 1.0 to 2.5 mol-%.

As mentioned above the propylene copolymer according to this invention must be produced with a metallocene catalyst.

Preferably, the propylene copolymer is produced in a sequential polymerization process using a specific metallocene catalyst. Accordingly, the propylene copolymer must be produced with a metallocene catalyst as disclosed in WO 2019/179959, which is incorporated by reference herewith.

The used metallocene catalyst complexes for the manufacture of the propylene copolymer is in particular defined by formula (I):

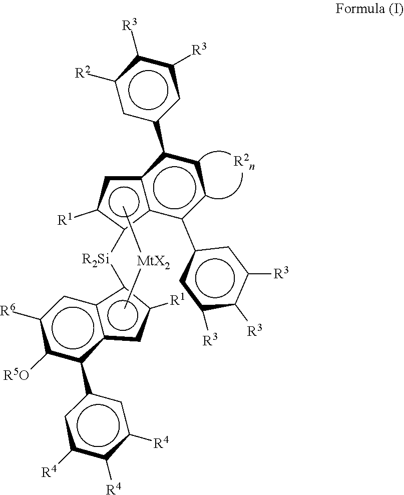

In a complex of formula (I) it is preferred if Mt is Zr or Hf, preferably Zr; each X is a sigma ligand. Most preferably, each X is independently a hydrogen atom, a halogen atom, C₁-C₆ alkoxy group or an R′ group, where R′ is a C₁-C₆ alkyl, phenyl or benzyl group. Most preferably, X is chlorine, benzyl or a methyl group. Preferably, both X groups are the same. The most preferred options are two chlorides, two methyl or two benzyl groups, especially two chlorides. For further preferred definitions of the residues, reference is made to WO 2019/179959.

Specifically preferred metallocene catalyst complexes are:
rac-anti-dimethylsilanediyl [2-methyl-4,8-bis-(4′-tert-butylphenyl)-1,5,6,7-tetrahydro-s-indacen-1-yl][2-methyl-4-(3′,5′-dimethyl-phenyl)-5-methoxy-6-tert-butylinden-1-yl] zirconium dichloride (MC-1);
rac-anti-dimethylsilanediyl [2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride (MC-2);
rac-anti-dimethylsilanediyl [2-methyl-4,8-bis-(3′,5′-dimethylphenyl)-1,5,6,7-tetrahydro-s-indacen-1-yl][2-methyl-4-(3′,5′-ditert-butyl-phenyl)-5-methoxy-6-tert-butylinden-1-yl] zirconium dichloride (MC-3)

The corresponding zirconium dimethyl analogues of the above defined three catalysts are also possible but less preferred. The most preferred catalyst is the one used for the inventive examples, i.e. MC-2.

### Cocatalyst

To form an active catalytic species it is normally necessary to employ a cocatalyst as is well known in the art. Here, a cocatalyst system comprising a boron containing cocatalyst and an aluminoxane cocatalyst is used in combination with the above defined metallocene catalyst complex.

Typical aluminoxane cocatalysts are state of the art. The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

As mentioned above the aluminoxane cocatalyst is used in combination with a boron containing cocatalyst.

Boron based cocatalysts of interest include those of formula (Z)

BY₃ (Z)
wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl) borane, tris(3,5-difluorophenyl) borane, tris(4-fluoromethylphenyl) borane, tris(2,4,6-trifluorophenyl) borane, tris(penta-fluorophenyl) borane, tris(tolyl) borane, tris(3,5-dimethyl-phenyl) borane, tris(3,5-difluorophenyl) borane and/or tris(3,4,5-trifluorophenyl) borane. Particular preference is given to tris(pentafluorophenyl) borane.

Preferred ionic compounds which can be used include: triethylammoniumtetra(phenyl)borate, tributylammoniumtetra(phenyl)borate, trimethylammoniumtetra(tolyl)borate, tributylammoniumtetra(tolyl)borate, tributylammoniumtetra(pentafluorophenyl)borate, tripropylammoniumtetra(dimethylphenyl)borate, tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N,N-diethylaniliniumtetra(phenyl)borate, N,N-dimethylaniliniumtetrakis(pentafluorophenyl)borate, N,N-di(propyl)ammoniumtetrakis(pentafluorophenyl)borate, di(cyclohexyl)ammoniumtetrakist(pentafluorophenyl)borate, triphenylphosphoniumtetrakis(phenyl)borate, triethylphosphoniumtetrakis(phenyl)borate, diphenylphosphoniumtetrakis(phenyl)borate, tri(methylphenyl)phosphoniumtetrakis(phenyl)borate, tri(dimethylphenyl)phosphoniumtetrakis(phenyl)borate, triphenylcarbeniumtetrakis(pentafluorophenyl)borate, or ferroceniumtetrakis(pentafluorophenyl)borate.

Preference is given to triphenylcarbeniumtetrakis(pentafluorophenyl)borate, N,N-dimethylcyclohexylammoniumtetrakis(pentafluorophenyl)borate or N,N-dimethylbenzylammoniumtetrakis(pentafluorophenyl)borate. Certain boron cocatalysts are especially preferred. Preferred borates comprise the trityl ion. Thus, the use of N,N-dimethylammonium-tetrakispentafluorophenylborate and Ph₃CB(PhF₅)₄ and analogues therefore are especially favoured.

It is especially preferred the combination of a borate cocatalyst, like Trityl tetrakis(pentafluorophenyl)borate, and methylaluminoxane (MAO).

Suitable amounts of cocatalyst will be well known to the skilled man.

The molar ratio of boron to the metal ion of the metallocene may be in the range of 0.5:1 to 10:1 mol/mol, preferably in the range of 1:1 to 10:1, especially in the range of 1:1 to 5:1 mol/mol.

The molar ratio of Al in the aluminoxane to the metal ion of the metallocene may be in the range of 1:1 to 2000:1 mol/mol, preferably in the range of 10:1 to 1000:1, and more preferably in the range of 50:1 to 500:1 mol/mol.

### Catalyst Manufacture

The metallocene catalyst complex can be used in combination with a suitable cocatalyst as a catalyst for the polymerization of propylene, e.g. in a solvent such as toluene or an aliphatic hydrocarbon, (i.e. for polymerization in solution), as it is well known in the art. Preferably, polymerization of propylene takes place in the condensed phase or in gas phase.

The catalyst of the invention can be used in supported or unsupported form. The particulate support material used is preferably an organic or inorganic material, such as silica, alumina or zirconia or a mixed oxide such as silica-alumina, in particular silica, alumina or silica-alumina. The use of a silica support is preferred. The skilled man is aware of the procedures required to support a metallocene catalyst.

Especially preferably, the support is a porous material so that the complex may be loaded into the pores of the support, e.g. using a process analogous to those described in WO 94/14856, WO 95/12622 and WO 2006/097497. The particle size is not critical but is preferably in the range of 5 to 200 μm, more preferably in the range of 20 to 80 μm. The use of these supports is routine in the art.

Alternatively, no support is used at all. Such a catalyst can be prepared in solution, for example in an aromatic solvent like toluene, by contacting the metallocene (as a solid or as a solution) with the cocatalyst, for example methylaluminoxane or a borane or a borate salt previously dissolved in an aromatic solvent, or can be prepared by sequentially adding the dissolved catalyst components to the polymerization medium.

Also, no external carrier may be used but the catalyst is still presented in solid particulate form. Thus, no external support material, such as inert organic or inorganic carrier, for example silica as described above is employed.

In order to provide the catalyst in solid form but without using an external carrier, it is preferred if a liquid/liquid emulsion system is used. Full disclosure of the necessary process can be found in WO 03/051934, which is herein incorporated by reference

The most preferred catalyst system is defined in the example section below (single site catalyst system 1 (SSCS1)).

The polymerization conditions in the sequential polymerization of the propylene copolymer are nothing specific and well known to the skilled person. Typically the first propylene copolymer fraction (F1) is produced in a slurry reactor and the second propylene copolymer fraction (F2) is produced in a gas phase reactor in the presence of a the first propylene copolymer fraction (F1). Regarding such multistage processes a preferred process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479, WO 00/68315, WO2015/082379 or in WO2015/011134.

It is well known that prior to the main polymerization a prepolymerization may take place.

The prepolymerisation may be carried out in any type of continuously operating polymerization reactor. The prepolymerisation may be carried out in a slurry polymerization or a gas phase polymerization reactor, preferably in a loop prepolymerisation reactor.

In a preferred embodiment, the prepolymerisation is conducted as bulk slurry polymerization in liquid propylene, i.e. the liquid phase mainly comprises propylene, with minor amount of other reactants and optionally inert components dissolved therein.

The prepolymerisation is carried out in a continuously operating reactor at an average residence time of 5 minutes up to 90 min. Preferably the average residence time is within the range of 10 to 60 minutes and more preferably within the range of 15 to 45 minutes.

The prepolymerisation reaction is typically conducted at a temperature of 0 to 50° C., preferably from 10 to 45° C., and more preferably from 15 to 35° C.

The pressure in the prepolymerisation reactor is not critical but must be sufficiently high to maintain the reaction mixture in liquid phase and is generally selected such that the pressure is higher than or equal to the pressure in the subsequent polymerization. Thus, the pressure may be from 20 to 100 bar, for example 30 to 70 bar.

In case a prepolymerisation step is performed, all of the catalyst mixture is introduced to the prepolymerisation step.

The precise control of the prepolymerisation conditions and reaction parameters is within the skill of the art.

As mentioned above the first propylene copolymer fraction (F1) is preferably produced in a slurry phase polymerization step, i.e. in the liquid phase.

The temperature in the slurry polymerization is typically from 50 to 110° C., preferably from 60 to 100° C. and in particular from 65 to 95° C. The pressure is from 1 to 150 bar, preferably from 10 to 100 bar.

The slurry polymerization may be conducted in any known reactor used for slurry polymerization. Such reactors include a continuous stirred tank reactor and a loop reactor. Loop reactors are generally known in the art and examples are given, for instance, in U.S. Pat. Nos. 4,582,816, 3,405,109, 3,324,093, EP-A-479186 and U.S. Pat. No. 5,391,654.

The residence time can vary in the reactor zones identified above. In one embodiment, the residence time in the slurry reactor, for example a loop reactor, is in the range of from 0.5 to 5 hours, for example 0.5 to 2 hours, while the residence time in the gas phase reactor generally will be in the range from 1 to 8 hours, like from 1.5 to 4 hours.

Into the slurry polymerization stage other components may also be introduced as it is known in the art. Thus, hydrogen is added to control the molecular weight of the polymer.

The slurry polymerization stage is followed by the gas phase polymerization stage in which the second propylene copolymer fraction (F2) is produced. It is preferred to conduct the slurry directly into the gas phase polymerization zone without a flash step between the stages. This kind of direct feed is described in EP-A-887379, EP-A-887380, EP-A-887381 and EP-A-991684.

That is, the reaction product of the slurry phase polymerization, i.e. the first propylene copolymer fraction (F1), which preferably is carried out in a loop reactor, is then transferred to the subsequent gas phase reactor in which the second propylene copolymer fraction (F2) is produced.

The polymerization in gas phase may be conducted in fluidized bed reactors, in fast fluidized bed reactors or in settled bed reactors or in any combination of these. When a combination of reactors is used then the polymer is transferred from one polymerization reactor to another. However it is preferred that the second propylene copolymer fraction (F2) is produced in one gas phase reactor.

Typically the gas phase reactor is operated at a temperature within the range of from 50 to 100° C., preferably from 65 to 95° C. The pressure is suitably from 10 to 40 bar, preferably from 15 to 30 bar

According to this invention the first propylene copolymer fraction (F1) is produced in the first step, i.e. in a first reactor, e.g. the loop reactor, whereas the second propylene copolymer fraction (F2) is produced in the subsequent step, i.e. in the second reactor, e.g. the gas phase reactor. In case the polymerization process of the first propylene copolymer fraction (F1) and the second propylene copolymer fraction (F2) contains also a prepolimerization step, then the first propylene copolymer fraction (F1) according to this invention is the polymer produced in the prepolymerization together with the polymer produced in the subsequent first step, in the first reactor, e.g. the loop reactor, whereas the second propylene copolymer fraction (F2) is the product of the second reactor, e.g. the gas phase reactor. The amount of polymer produced in the prepolymerization step is comparatively small compared to the quantities produced in the first reactor and therefore has no great influence on the properties of the polypropylene from the first reactor.

The preferred properties of the first propylene copolymer fraction (F1) and the second propylene copolymer fraction (F2) have been mentioned above.

### The Alpha-Nucleating Agent

Another important component of the polypropylene composition is an alpha-nucleating agent which is present in the range of 0.01 to 1.0 wt.-%, more preferably in the range of 0.03 to 0.8 wt.-%, yet more preferably in the range of 0.05 to 0.5 wt.-%, based on the total weight of the composition.

Preferred examples of the alpha-nucleating agents are disclosed in “Plastics Additives Handbook”, Hans Zweifel, 6th Edition, p. 967-990.

Among all alpha-nucleating agents, aluminium hydroxy-bis [2,4,8,10-tetrakis(1,1-dimethylethyl)-6-hydroxy-12H-dibenzo-[d,g]-dioxa-phoshocin-6-oxidato] based nucleating agents like ADK NA-21, NA-21 E, NA-21 F, etc., sodium-2,2′-methylene-bis(4,6-di-t-butylphenyl)phosphate (ADK NA-11), aluminium-hydroxy-bis [2,2′-methylene-bis(4,6-di-t-butyl-phenyl)-phosphate], sorbitol-based nucleating agents, i.e. di(alkylbenzylidene) sorbitols like 1,3:2,4-25 dibenzylidene sorbitol, 1,3:2,4-di(4-methylbenzylidene) sorbitol, 1,3:2,4-di(4-ethylbenzylidene) sorbitol and 1,3:2,4-Bis(3,4-dimethylbenzylidene) sorbitol, as well as nonitol derivatives, like 1,2,3-trideoxy-4,6;5,7-bis-O-[(4-propylphenyl)methylene] nonitol, and benzene-trisamides like substituted 1,3,5-benzenetrisamides as N,N′,N″-tris-tert-butyl-1,3,5-benzenetricarboxamide, N,N′,N″-tris-cyclohexyl-1,3,5-benzene-tricarboxamide and N-[3,5-bis-(2,2-dimethyl-propionylamino)-phenyl]-2,2-dimethyl-propionamide, wherein 1,3:2,4-di(4-methylbenzylidene) sorbitol and N-[3,5-bis-(2,2-dimethyl-propionylamino)-phenyl]-2,2-dimethyl-propionamide and polymeric nucleating agents selected from the group consisting of vinylcycloalkane polymers and vinylalkane polymers are particularly preferred.

Preferably the polypropylene composition contains at least one alpha-nucleating agent selected from the group consisting of polymeric nucleating agent, sorbitol-based nucleating agent, nonitol-based nucleating agent and benzene-trisamide-based nucleating agent. Still more preferably the alpha-nucleating agent(s) is/are selected from the group consisting of 1,2,3-trideoxy-4,6;5,7-bis-O-[(4-propylphenyl)methylene] nonitol, bis-(3,4-dimethylbenzylidene)-sorbitol (DMDBS) and poly vinylcyclohexane (p-VCH). Yet more preferably the alpha-nucleating agent(s) present in the polypropylene composition is/are selected from the group consisting of 1,2,3-trideoxy-4,6;5,7-bis-O-[(4-propylphenyl)methylene] nonitol, bis-(3,4-dimethylbenzylidene)-sorbitol (DMDBS) and poly vinylcyclohexane (p-VCH).

Thus, it is especially preferred that the alpha-nucleating agent(s) present in the polypropylene composition is/are selected from the group consisting of poly vinylcyclohexane (p-VCH), 1,2,3-trideoxy-4,6;5,7-bis-O-[(4-propylphenyl)methylene] nonitol and bis-(3,4-dimethylbenzylidene)-sorbitol (DMDBS), wherein further the total amount of the alpha-nucleating agent(s), based on the total amount of the polypropylene composition, is in the range of 0.05 to 0.5 wt.-%.

### Further Components

As stated above the polypropylene composition must comprise the propylene copolymer as main component and an alpha-nucleating agent. Additionally the polypropylene composition may comprise typical additives other than the alpha-nucleating agent, like antioxidants, antistatic agents and antifogging agents, and other polypropylene(s) being different to the propylene copolymer.

Typically the total amount of additives, excluding the alpha-nucleating agent, based on the polypropylene composition, shall not exceed 1.0 wt.-%, preferably is in the range of 0.05 to 1.0 wt.-%.

The alpha-nucleating agent and the additives may be added to the polypropylene composition together with low amounts of polyolefins being different to the propylene copolymer. The term “different to” in this context means that the polyolefin differs from the propylene copolymer in at least one typical characterizing feature in the field of polymers, like molecular weight, for instance in terms of melt flow rate MFR₂ (230° C.; 2.16 kg), melting point and/or misinsertions, for instance in 2, 1 erythro regio-defects, as well as the absence of comonomers as required for the propylene copolymer. Accordingly the polyolefins used for this purpose are preferably propylene homopolymers and not propylene copolymers. Accordingly, such polypropylene, more preferably such propylene homopolymer, has a melt flow rate MFR₂ (230° C.; 2.16 kg), measured according to ISO 1133, in the range of 1.0 to 25.0 g/10 min. Even more preferably, such polypropylene, still more preferably such propylene homopolymer, has been produced with a Ziegler-Natta catalyst of the 4^{th} or 5^{th} generation (cf. pages 17/18 of “Polypropylene Handbook” 2^{nd} Edition of Nello Pasquini) and thus has a highest melting peak temperature T_{p,m} measured by DSC (scan rate of 10° C./min; second heating step) in the range of 162 to 169° C. A typical additional feature of such a polypropylene, more preferably of such a propylene homopolymer, produced with a Ziegler-Natta catalyst of the 4^{th} or 5^{th} generation is that it does not show 2,1 erythro regio-defects, i.e. has no detectable 2, 1 erythro regio-defects when analyzed according to this invention. Accordingly it is preferred that the polypropylene composition comprise one or more propylene homopolymer(s), wherein said one or more propylene homopolymer(s), has/have preferably a melt flow rate MFR₂ (230° C.; 2.16 kg), measured according to ISO 1133, in the range of 1.0 to 25.0 g/10 min. More preferably, the one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C. Even more preferred the one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2,1 erythro regio-defects measured by ¹³C NMR. The total amount of polyolefins as defined in this paragraph, based on the amount of the polypropylene composition, is in the range of 0.5 to 4.0 wt.-%. Accordingly it is especially preferred that the polyolefins are one or more propylene homopolymer(s), wherein further total amount of said one or more propylene homopolymer(s), based on the amount of the polypropylene composition, is in the range of 0.5 to 4.0 wt.-%.

Accordingly the polypropylene composition according to this invention comprises, preferably consists of,
(a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
(b) 0.01 to 1.0 wt.-%, more preferably 0.05 to 0.5 wt.-%, based on the total weight of the composition, of an alpha-nucleating agent,
(c) 0.05 to 1.0 wt.-%, based on the total weight of the composition, of additives being not an alpha-nucleating agent, and
(d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2,1 erythro regio-defects measured by ¹³C NMR.

### Properties of the Polypropylene Composition

As mentioned above the main component of the polypropylene composition is the propylene copolymer. Accordingly the specific features of the propylene copolymer can be also identified on the final polypropylene composition. Or in other words important features of the polypropylene composition are identical or at least very similar to the propylene copolymer. The following properties can be in particular mentioned: the amount of comonomer, the type of comonomer, the 2, 1 erythro regio-defects, molecular weight distribution and the melt flow rate.

Accordingly the polypropylene composition has a comonomer content in the range of 2.0 to 6.5 mol-%, preferably in the range of 3.0 to 5.5 mol-%, measured by ¹³C-NMR. The comonomer of the polypropylene composition is selected from the group consisting of 1-butene, 1-hexene and 1-octene, preferably the comonomer is 1-butene. For the avoidance of doubt, the main monomer of the polypropylene composition is propylene, whereas the comonomer can be only selected from the group consisting of 1-butene, 1-hexene and 1-octene, preferably the comonomer is 1-butene. Thus in a very preferred embodiment the sole comonomer of the polypropylene composition is 1-butene in an amount of 2.0 to 6.5 mol-%, preferably in the range of 3.0 to 5.5 mol-%, measured by ¹³C-NMR.

Further the polypropylene composition has 2, 1 erythro regio-defects in the range of >0.35 to 0.85 mol-%, measured by ¹³C NMR, more preferably in the range of 3.0 to 5.5 mol-% and a melt flow rate MFR₂ (230° C.; 2.16 kg), measured according to ISO 1133, in the range of 15 to 100 g/10 min, more preferably in the range of 15 to 80 g/10 min.

A further advantage of the propylene copolymer of this invention is its rather low xylene cold soluble content. Accordingly the polypropylene composition has a xylene cold soluble (XCS) fraction, determined at 25° C. according to ISO 16152, in the range of 0.1 to 1.0 wt.-%, more preferably in the range of 0.2 to 0.6 wt.-%. A low soluble content is also an indicator that the polypropylene composition is not a heterophasic system but is monophasic, like the propylene copolymer being the main polymer component in the polypropylene composition.

Further it is preferred that the polypropylene composition has a molecular weight distribution (MWD) determined by Gel Permeation Chromatography (GPC) in the range of 2.0 to 5.0, more preferably in the range of 2.1 to 4.5, still more preferably in the range of 2.2 to 3.5.

The polypropylene composition according to this invention can be defined further by its melting and crystallization behavior. The polypropylene composition according to this invention is characterized in particular by a relatively small gap between melting and crystallization temperature. For defining the melting and crystallization temperature always the highest melting peak temperature T_{p,m} measured by DSC (scan rate of 10° C./min; second heating step) and the highest crystallization peak temperature T_{p,c} measured by DSC (scan rate of 10° C./min; cooling step) is used. Thereby it is especially preferred that the polypropylene composition has a highest melting peak temperature T_{p,m} which is rather high for metallocene produced propylene copolymers.

Accordingly, it is preferred that the polypropylene composition according to this invention
(a) has the highest melting peak temperature T_{p,m} measured by DSC (scan rate of 10° C./min; second heating step) in the range of 140 to 152° C., and
(b) complies with the equation 1, preferably equation 1a,

$$24 ° C . < Tp , m - Tp , c < 32 ° C . \qquad ( 1 )$$

$$25 ° C . < Tp , m - Tp , c < 30 ° C . \qquad ( 1 a )$$

wherein
“T_{p,m}” is the highest melting peak temperature T_{p,m} [° C.] measured by DSC (scan rate of 10° C./min; second heating step) and
“T_{p,c}” is the highest crystallization peak temperature T_{p,c} [° C.] measured by DSC (scan rate of 10° C./min; cooling step).

More preferably the polypropylene composition according to this invention has
(a) the highest melting peak temperature T_{p,m} measured by DSC (scan rate of 10° C./min; second heating step) in the range of 140 to 152° C., and
(b) the highest crystallization peak temperature T_{p,c} measured by DSC (scan rate of 10° C./min; cooling step) in the range of 115 to 125° C.,
wherein further the polypropylene composition complies with the equation 1, preferably equation 1a.

$$24 ° C . < Tp , m - Tp , c < 32 ° C . \qquad ( 1 )$$

$$25 ° C . < Tp , m - Tp , c < 30 ° C . \qquad ( 1 a )$$

wherein
“T_{p,m}” is the highest melting peak temperature T_{p,m} [° C.] measured by DSC (scan rate of 10° C./min; second heating step) and
“T_{p,c}” is the highest crystallization peak temperature T_{p,c} [° C.] measured by DSC (scan rate of 10° C./min; cooling step).

### PREFERRED EMBODIMENTS

In the following some especially preferred embodiments of the invention are listed.

A living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein
the injection molded article is made as a single piece,
wherein further the living hinge and the injection molded article consists of a polypropylene composition
said polypropylene composition comprises
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
wherein further the composition has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (ii) 2, 1 erythro regio-defects, measured by ¹³C NMR, in the range of >0.35 to 0.85 mol-%, preferably in the range of 0.4 to 0.75 mol-%, and
   (iii) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.

Still more preferably the invention is directed to a living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein
the injection molded article is made as a single piece,
wherein further the living hinge and the injection molded article consists of a polypropylene composition
said polypropylene composition comprises
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
wherein further the propylene copolymer has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene, and
   (ii) 2, 1 erythro regio-defects in the range of >0.35 to 0.85 mol-%, preferably in the range of 0.4 to 0.75 mol-%. measured by ¹³C NMR, wherein still further the composition has
   (iii) a comonomer content, measured by ¹³C-NMR, is in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (iv) 2,1 erythro regio-defects in the range of >0.35 to 0.85 mol-%, preferably in the range of 0.4 to 0.75 mol-%. measured by ¹³C NMR, and
   (v) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.

Still yet more preferably the invention is directed to a living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein
the injection molded article is made as a single piece,
wherein further the living hinge and the injection molded article consists of a polypropylene composition
said polypropylene composition consists of,
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
   (c) 0.05 to 1.0 wt.-%, based on the total weight of the composition, of additives being not an alpha-nucleating agent, and
   (d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2, 1 erythro regio-defects measured by ¹³C NMR,
wherein further the composition has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (ii) 2, 1 erythro regio-defects, measured by ¹³C NMR, in the range of >0.35 to 0.85 mol-%, preferably in the range of 0.4 to 0.75 mol-%, and
   (iii) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.

In another preferred embodiment the invention is directed to a living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein the injection molded article is made as a single piece,
wherein further the living hinge and the injection molded article consists of a polypropylene composition
said polypropylene composition consists of,
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent,
   (c) 0.05 to 1.0 wt.-%, based on the total weight of the composition, of additives being not an alpha-nucleating agent, and
   (d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2, 1 erythro regio-defects measured by ¹³C NMR,
wherein further the propylene copolymer has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene, and
   (ii) 2, 1 erythro regio-defects in the range of >0.35 to 0.85 mol-%, preferably in the range of 0.4 to 0.75 mol-%. measured by ¹³C NMR, wherein still further the composition has
   (iii) a comonomer content, measured by ¹³C-NMR, is in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (iv) 2, 1 erythro regio-defects in the range of >0.35 to 0.85 mol-%, preferably in the range of 0.4 to 0.75 mol-%. measured by ¹³C NMR, and
   (v) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.

In still another preferred embodiment the invention the invention is directed to a living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein the injection molded article is made as a single piece,
wherein further the living hinge and the injection molded article consists of a polypropylene composition
said polypropylene composition consists of,
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
   (c) 0.05 to 1.0 wt.-%, based on the total weight of the composition, of additives being not an alpha-nucleating agent, and
   (d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2, 1 erythro regio-defects measured by ¹³C NMR,
wherein further the composition has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (ii) 2, 1 erythro regio-defects, measured by ¹³C NMR, in the range of >0.35 to 0.85 mol-%, preferably in the range of 0.4 to 0.75 mol-%, and
   (iii) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.
   (iv) the highest melting peak temperature T_{p,m} measured by DSC (scan rate of 10° C./min; second heating step) in the range of 140 to 152° C., and wherein still further the composition
   (v) complies with the equation 1, preferably equation 1a,

$$24 ° C . < Tp , m - Tp , c < 32 ° C . \qquad ( 1 )$$

$$25 ° C . < Tp , m - Tp , c < 30 ° C . \qquad ( 1 a )$$

wherein
“T_{p,m}” is the highest melting peak temperature T_{p,m} [° C.] measured by DSC (scan rate of 10° C./min; second heating step) and
“T_{p,c}” is the highest crystallization peak temperature T_{p,c} [° C.] measured by DSC (scan rate of 10° C./min; cooling step).

In still yet another preferred embodiment the invention the invention is directed to a living hinge, preferably an injection molded living hinge, or
an Injection molded article, preferably a thin wall injection molded article, wherein the thin wall injection molded article has a wall thickness up to 2.00 mm, comprising two rigid pieces which are connected by at least one living hinge, wherein the injection molded article is made as a single piece,
wherein further the living hinge and the injection molded article consists of a polypropylene composition
said polypropylene composition consists of,
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
   (c) 0.05 to 1.0 wt.-%, based on the total weight of the composition, of additives being not an alpha-nucleating agent, and
   (d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2,1 erythro regio-defects measured by ¹³C NMR,
wherein further the propylene copolymer has
   (i) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene, and
   (ii) 2, 1 erythro regio-defects in the range of >0.35 to 0.85 mol-%, preferably in the range of 0.4 to 0.75 mol-%. measured by ¹³C NMR,
wherein still further the composition has
   (iii) a comonomer content, measured by ¹³C-NMR, in the range of 2.0 to 6.5 mol-%, preferably in the range of 3.0 to 5.5 mol-%,
   (iv) 2, 1 erythro regio-defects, measured by ¹³C NMR, in the range of >0.35 to 0.85 mol-%, preferably in the range of 0.4 to 0.75 mol-%, and
   (v) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min.
   (vi) the highest melting peak temperature T_{p,m} measured by DSC (scan rate of 10° C./min; second heating step) in the range of 140 to 152° C., and
wherein still further the composition
   (vii) complies with the equation 1, preferably equation 1a,

$$24 ° C . < Tp , m - Tp , c < 32 ° C . \qquad ( 1 )$$

$$25 ° C . < Tp , m - Tp , c < 30 ° C . \qquad ( 1 a )$$

wherein
“T_{p,m}” is the highest melting peak temperature T_{p,m} [° C.] measured by DSC (scan rate of 10° C./min; second heating step) and
“T_{p,c}” is the highest crystallization peak temperature T_{p,c} [C] measured by DSC (scan rate of 10° C./min; cooling step).

The invention is also directed to a living hinge, preferably an injection molded living hinge, or an Injection molded article, preferably a thin wall injection molded article, wherein the thin wall injection molded article has a wall thickness up to 2.00 mm, comprising two rigid pieces which are connected by at least one living hinge, wherein
the injection molded article is made as a single piece,
wherein further the living hinge and the injection molded article consists of a polypropylene composition
said polypropylene composition consists of,
   (a) at least 95.0 wt.-%, more preferably at least 97.0 wt.-%, based on the total weight of the composition, of a propylene copolymer, said propylene copolymer has a comonomer selected from the group consisting of 1-butene, 1-hexene and 1-octene, preferably said propylene copolymer is a propylene 1-butene copolymer,
   (b) 0.01 to 1.0 wt.-%, more preferably 0.05 to 0.5 wt.-%, based on the total weight of the composition, of an alpha-nucleating agent, preferably the alpha-nucleating agent is selected from the group consisting of polymeric nucleating agent, sorbitol-based nucleating agent, nonitol-based nucleating agent and/or benzene-trisamide-based nucleating agent,
   (c) 0.05 to 1.0 wt.-%, based on the total weight of the composition, of additives being not an alpha-nucleating agent, and
   (d) optionally 0.5 to 4.0 wt.-%, based on the total weight of the composition, of one or more propylene homopolymer(s), preferably wherein said one or more propylene homopolymer(s) has/have a melt flow rate MFR₂ (230° C.; 2.16 kg), measured according to ISO 1133, in the range of 1.0 to 25.0 g/10 min, more preferably wherein said one or more propylene homopolymer(s) has/have a melt flow rate MFR₂ (230° C.; 2.16 kg), measured according to ISO 1133, in the range of 1.0 to 25.0 g/10 min and a highest melting peak temperature T_{p,m} measured by DSC (scan rate of 10° C./min; second heating step) in the range of 162 to 169° C., still more preferably wherein said one or more propylene homopolymer(s) has/have a melt flow rate MFR₂ (230° C.; 2.16 kg), measured according to ISO 1133, in the range of 1.0 to 25.0 g/10 min, a highest melting peak temperature T_{p,m} measured by DSC (scan rate of 10° C./min; second heating step) in the range of 162 to 169° C. and no detectable 2,1 erythro regio-defects measured by ¹³C NMR,
wherein further the propylene copolymer has
   (i) a comonomer content, measured by ¹³C-NMR, in the range of 2.0 to 6.5 mol-%, preferably in the range of 3.0 to 5.5 mol-%, and
   (ii) 2,1 erythro regio-defects in the range of >0.35 to 0.85 mol-%, preferably in the range of 0.4 to 0.75 mol-%. measured by ¹³C NMR, wherein still further the composition has
   (iii) a comonomer content, measured by ¹³C-NMR, in the range of 2.0 to 6.5 mol-%, preferably in the range of 3.0 to 5.5 mol-%, the comonomer is selected from the group consisting of 1-butene, 1-hexene and 1-octene, preferably the comonomer is 1-butene,
   (iv) 2,1 erythro regio-defects, measured by ¹³C NMR, in the range of >0.35 to 0.85 mol-%, preferably in the range of 0.4 to 0.75 mol-%, and
   (v) a melt flow rate MFR₂ (230° C.; 2.16 kg), measured according to ISO 1133, in the range of 15 to 100 g/10 min, preferably in the range of 16 to 90 g/10 min, more preferably in the range of 17 to 80 g/10 min,
   (vi) a xylene cold soluble (XCS) fraction, determined at 25° C. according to ISO 16152, in the range of 0.1 to 1.0 wt.-%, preferably in the range of 0.2 to 0.6 wt.-%,
   (vii) a molecular weight distribution (MWD) determined by Gel Permeation Chromatography (GPC) in the range of 2.0 to 5.0, more preferably in the range of 2.1 to 4.5, still more preferably in the range of 2.2 to 3.5,
   (viii) the highest melting peak temperature T_{p,m} measured by DSC (scan rate of 10° C./min; second heating step) in the range of 140 to 152° C., and
wherein still further the composition
   (ix) complies with the equation 1, preferably equation 1a,

$$24 ° C . < Tp , m - Tp , c < 32 ° C . \qquad ( 1 )$$

$$25 ° C . < Tp , m - Tp , c < 30 ° C . \qquad ( 1 a )$$

wherein
“T_{p,m}” is the highest melting peak temperature T_{p,m} [° C.] measured by DSC (scan rate of 10° C./min; second heating step) and
“T_{p,c}” is the highest crystallization peak temperature T_{p,c} [° C.] measured by DSC (scan rate of 10° C./min; cooling step).

In the following the invention is described by way of examples.

### A. Measuring Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the comonomer content of the polymers. Quantitative ¹³C {¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probe head at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. Standard single-pulse excitation was employed utilising the NOE at short recycle delays and the RS-HEPT decoupling scheme. A total of 1024 (1k) transients were acquired per spectra using a 3 s recycle delay.

Quantitative ¹³C {¹H} NMR spectra were processed, integrated and relevant quantitative properties determined from the integrals. All chemical shifts are internally referenced to the methyl isotactic pentad (mmmm) at 21.85 ppm.

### Basic Comonomer Content Method Spectral Analysis Method:

Characteristic signals corresponding to the incorporation of 1-butene were observed and the comonomer content quantified in the following way.

The amount of 1-butene incorporated in PPBPP isolated sequences was quantified using the integral of the α_{B2} sites at 43.6 ppm accounting for the number of reporting sites per comonomer:

$$B = {I}_{α} / 2$$

The amount of 1-butene incorporated in PPBBPP double consecutively sequences was quantified using the integral of the αα_{B2B2} site at 40.5 ppm accounting for the number of reporting sites per comonomer:

$$BB = 2 * {I}_{α α}$$

When double consecutive incorporation was observed the amount of 1-butene incorporated in PPBPP isolated sequences needed to be compensated due to the overlap of the signals α_{B2} and α_{B2B2} at 43.9 ppm:

$$B = ( {I}_{α} - 2 * {I}_{α α} ) / 2$$

The total 1-butene content was calculated based on the sum of isolated and consecutively incorporated 1-butene:

$${B}_{total} = B + BB$$

The amount of propene was quantified based on the main Sαα methylene sites at 46.7 ppm and compensating for the relative amount of αB2 and αB2B2 methylene unit of propene not accounted for (note B and BB count number of butene monomers per sequence not the number of sequences):

$${P}_{total} = {I}_{S αα} + B + BB / 2$$

The total mole fraction of 1-butene in the polymer was then calculated as:

$${f}_{B} = {B}_{total} / ( {B}_{total} + {P}_{total} )$$

The full integral equation for the mole fraction of 1-butene in the polymer was:

$${f}_{B} = ( ( ( {I}_{α} - 2 * {I}_{αα} ) / 2 ) + ( 2 * {I}_{αα} ) ) / ( {I}_{S αα} + ( ( {I}_{α} - 2 * {I}_{αα} ) / 2 ) + ( ( 2 * {I}_{αα} ) / 2 ) ) + ( ( {I}_{α} - 2 * {I}_{αα} ) / 2 ) + ( 2 * I αα ) )$$

This simplifies to:

$${f}_{B} = ( {I}_{α} / 2 + {I}_{α α} ) / ( {I}_{S αα} + {I}_{α} + {I}_{α α} )$$

The total incorporation of 1-butene in mole percent was calculated from the mole fraction in the usual manner:

$$B [ mol - \% ] = 100 * {f}_{B}$$

The total incorporation of 1-butene in weight percent was calculated from the mole fraction in the standard manner:

$$B [ wt . - 1 \% ] = 100 * ( {f}_{B} * 56. 11 ) / ( ( {f}_{B} * 56. 11 ) + ( ( 1 - {f}_{B} ) * 42. 08 ) )$$

Details of these procedures can be found in Katja Klimke, Matthew Parkinson, Christian Piel, Walter Kaminsky Hans Wolfgang Spiess, Manfred Wilhelm, Macromol. Chem. Phys. 2006, 207, 382; Matthew Parkinson, Katja Klimke, Hans Wolfgang Spiess, Manfred Wilhelm, Macromol. Chem. Phys. 2007, 208, 2128; Patrice Castignolles, Robert Graf, Matthew Parkinson, Manfred Wilhelm, Marianne Gaborieau: Polymer 2009, 50, 2373; M. Pollard, K. Klimke, R. Graf, H. W. Spiess, M. Wilhelm, O. Sperber, C. Piel, W. Kaminsky, Macromolecules 2004, 37, 813; Xenia Filip, Carmen Tripon, Claudiu Filip, J. Magn. Reson. 2005, 176, 239; John M. Griffin, Carmen Tripon, Ago Samoson, Claudiu Filip, Steven P. Brown, Mag. Res. in Chem. 2007, 45 (S1), S198; J. Randall Rev. Macromol. Chem. Phys. 1989, C29, 201.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR₂ of the polypropylene is determined at a temperature of 230° C. and a load of 2.16 kg.

### Calculation of Melt Flow Rate MFR₂ (230° C.) of the Second Polypropylene (PP2):

$$MFR ( PP 2 ) = {10}^{[ \frac{log ( MFR ( PP ) ) - w ( PP 1 ) \times log ( MFR ( PP 1 ) )}{w ( PP )} ]}$$

wherein
w(PP1) is the weight fraction [in wt.-%] of the first polypropylene (PP1),
w(PP2) is the weight fraction [in wt.-%] of the second polypropylene (PP2),
MFR(PP1) is the melt flow rate MFR₂ (230° C.) [in g/10 min] the first polypropylene (PP1),
MFR(PP) is the melt flow rate MFR₂ (230° C.) [in g/10 min] of the reactor powder of the polypropylene (PP),
MFR(PP2) is the calculated melt flow rate MFR₂ (230° C.) [in g/10 min] of the second polypropylene (PP2).

### Molecular Weight

Molecular weight averages (Mz, Mw and Mn) and Molecular weight distribution (MWD), i.e. Mw/Mn, were determined by Gel Permeation Chromatography (GPC) according to ISO 16014-4:2003 and ASTM D 6474-99 using the following formulas:

$${M}_{n} = \frac{{\sum }_{i = 1}^{N} {A}_{i}}{\sum ( {A}_{i} / {M}_{i} )}$$

$${M}_{w} = \frac{{\sum }_{i = 1}^{N} ( {A}_{i} \times {M}_{i} )}{\sum {A}_{i}}$$

$${M}_{z} = \frac{{\sum }_{i = 1}^{N} ( {A}_{i} \times {M}_{i}^{2} )}{\sum ( {A}_{i} / {M}_{i} )}$$

where Ai and Mi are the chromatographic peak slice area and polyolefin molecular weight (MW).
A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/l 2,6-Di-tert-butyl-4-methyl-phenol) as solvent at 160° C. and at a constant flow rate of 1 ml/min. 200 μL of sample solution were injected per analysis. The column set was calibrated using universal calibration (according to ISO 16014-2:2003) with at least 15 narrow MWD polystyrene (PS) standards in the range of 0.5 kg/mol to 11500 kg/mol. Mark Houwink constants used for PS, PE and PP are as described per ASTM D 6474-99. All samples were prepared by dissolving 5.0 to 9.0 mg of polymer in 8 ml (at 160° C.) of stabilized TCB (same as mobile phase) for 2.5 hours for PP or 3 hours for PE at 160° C. under continuous gentle shaking in the autosampler of the GPC instrument.

### The Xylene Soluble Fraction at Room Temperature (XCS, Wt.-%):

The amount of the polymer soluble in xylene was determined at 25° C. according to ISO 16152; 5th edition; 2005 Jul. 1.

DSC analysis, melting peak temperature (T_{p,m}) and heat of fusion (H_{f}), crystallization peak temperature (T_{p,c}) and heat of crystallization (H_{c}): measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Highest crystallization peak temperature (T_{p,c}) and heat of crystallization (H_{c}) are determined from the cooling step, while highest melting peak temperature (T_{p,m}) and heat of fusion (H_{f}) are determined from the second heating step.

### Flexural Modulus

The Flexural Modulus was determined according to ISO 178 method A (3-point bending test) on 80×10×4 mm specimens. Following the standard, a test speed of 2 mm/min and a span length of 16 times the thickness was used. The testing temperature was 23±2° C. Injection moulding was carried out according to ISO 19069-2 using a melt temperature of 200° C. for all materials irrespective of material melt flow rate.

### Haze

Haze was determined according to ASTM D1003-00 on 60×60×1 mm³ plaques injection molded in line with EN ISO 1873-2 using a melt temperature of 230° C.

### Charpy Notched Impact Strength (NIS)

The Charpy notched impact strength (NIS) was measured according to ISO 179 1 eA at +23° C., using injection moulded bar test specimens of 80×10×4 mm prepared in accordance with EN ISO 1873-2.

### B. Preparation of Polypropylene Composition

Catalyst for the inventive examples

### Catalyst Complex

The following metallocene complex has been used as described in WO 2019/179959:

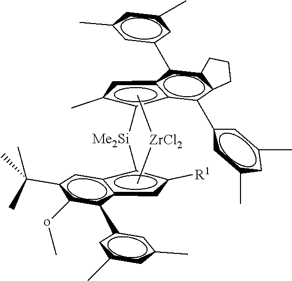

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressuring and depressurising with nitrogen using manual valves. Then toluene (22 kg) was added. The mixture was stirred for 15 min. Next 30 wt. % solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° C. under nitrogen flow for 2 hours and then for 5 hours under vacuum (−0.5 barg) with stirring. MAO treated support was collected as a free-flowing white powder found to contain 12.2% Al by weight.

### Single Site Catalyst System 1 (SSCS1) Preparation

30 wt. % MAO in toluene (0.7 kg) was added into a steel nitrogen blanked reactor via a burette at 20° C. Toluene (5.4 kg) was then added under stirring. The metallocene complex as described above (93 g) was added from a metal cylinder followed by flushing with 1 kg toluene. The mixture was stirred for 60 minutes at 20° C. Trityl tetrakis(pentafluorophenyl)borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 h and additionally for 5 h under vacuum (−0.5 barg) under stirring.

Dried catalyst was sampled in the form of pink free flowing powder containing 13.9% Al and 0.11% Zr.

TABLE 1
Polymerization conditions

| Polymer | | Poly 1 |
|---|---|---|
| Catalyst | | SSCS1 |
| Prepoly reactor | | |
| Temp. | [° C.] | 20 |
| Press. | [kPa] | 4756 |
| Residence time | [h] | 0.33 |
| Loop reactor | | |
| Temp. | [° C.] | 68 |
| Press. | [kPa] | 4923 |
| Feed H2/C3 ratio | [mol/kmol] | 0.13 |
| Feed C4/C3 ratio | [mol/kmol] | 44.0 |
| Polymer Split* | [wt.-%] | 47 |
| MFR₂* | [g/10 min] | 24 |
| Total C4* | [wt.-%] | 4.4 |
| Total C4* | [mol-%] | 3.3 |
| XCS* | [wt.-%] | 0.3 |
| GPR (F2) | | |
| Temp. | [° C.] | 80 |
| Press. | [kPa] | 2500 |
| H2/C3 ratio | [mol/kmol] | 1.6 |
| C4/C3 ratio | [mol/kmol] | 38.0 |
| Polymer Split | [wt.-%] | 53 |
| C4** | [wt.-%] | 6.7 |
| C4** | [mol-%] | 5.11 |
| MFR₂*** | [g/10 min] | 19 |
| Pellet | | |
| MFR₂ | [g/10 min] | 21 |
| Total C4 | [wt.-%] | 5.6 |
| Total C4 | [mol-%] | 4.3 |
| 2,1 erythro | [mol-%] | 0.61 |
| XCS | [wt.-%] | 0.4 |

*“MFR₂”, “Total C4”, “XCS” and “Polymer Split” are measured in the loop reactor, i.e. is the combination of Prepoly Reactor and Loop reactor and considered as the first propylene copolymer fraction (F1)
**“C4” is calculated from the “Total C4” measured in the loop reactor and “Total C4” measured from the pellet
***“MFR₂” is calculated from the MFR₂ measured in the loop reactor and the MFR₂ of the pellet using the formula given above defining the measurement of MFR₂

TABLE 2
Polypropylene composition

| | | IE1 | CE1 | CE2 | CE3 |
|---|---|---|---|---|---|
| Poly1 | [wt.-%] | 97.66 | — | — | — |
| Poly2 | [wt.-%] | 2.00 | 100 | — | — |
| Poly3 | [wt.-%] | — | — | 100 | — |
| Poly4 | [wt.-%] | — | — | — | 100 |
| AO1 | [wt.-%] | 0.05 | — | — | — |
| AO2 | [wt.-%] | 0.05 | — | — | — |
| CS | [wt.-%] | 0.04 | — | — | — |
| AN1 | [wt.-%] | 0.2 | — | — | — |
| C4 | [mol-%] | 4.3 | 0 | 0 | 0 |
| C2 | [mol-%] | 0 | 0 | 0 | 5.8 |
| XCS | [wt.-%] | 0.4 | 1.5 | 2.0 | 6.5 |
| 2,1 erythro | [mol-%] | 0.60 | 0.0 | 0.0 | 0.0 |
| MWD | [—] | 2.6 | 5.8 | 4.0 | 5.6 |
| MFR₂ | [g/10 min] | 21 | 20 | 19 | 30 |
| T_{p, c} | [° C.] | 118.0 | 129 | 111 | 122 |
| T_{p, m} | [° C.] | 145.5 | 165 | 161 | 150 |
| FM | [MPa] | 1359 | 2000 | 1220 | 1050 |
| Haze | [%] | 9.0 | 57 | 35 | 20 |
| FM/haze | [MPa/%] | 151 | 35 | 35 | 53 |
| Charpy NIS (23° C.) | [kJ/m²] | 3.7 | 2.5 | 2.2 | 5.5 |

“FM” is the flexural modulus;
“Poly2” is the commercial alpha-nucleated polypropylene homopolymer “HF955MO” of BorealisAG;
“Poly3” is the commercial polypropylene homopolymer “HF420FB” of Borealis AG
“Poly4” is the commercial alpha-nucleated propylene-ethylene copolymer “BorePure RG466MO” of Borealis AG;
“AO1” is the sterically hindered phenol pentaerythrityl-tetrakis(3-(3′,5′-di-tert. butyl-4-hydroxyphenyl)-propionate “Irganox 1010” of BASF
“AO2” is the phosphorous based antioxidant tris (2,4-di-t-butylphenyl) phosphite “Irgafos 168” of BASF
“CS” is calcium stearate
“AN1” is the commercial alpha-nucleating agent Millad 3988 of Milliken containing bis-(3,4-dimethylbenzylidene)-sorbitol (DMDBS);

### C. Preparation of Lunch Boxes

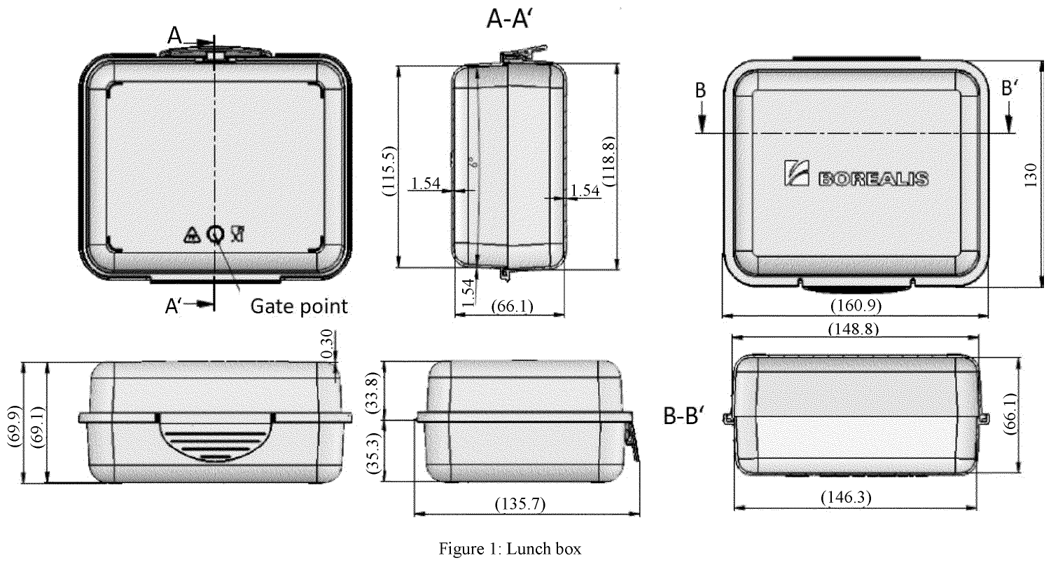

Lunch boxes of an outer dimension of 160.9×130.0×69.1 mm³ having rounded corners and edges as shown in FIG. 1 were produced by injection molding. Said lunch boxes consist of a lower half of 35.3 mm height and an upper part of 33.8 mm height, connected with a first living hinge in position A′ and equipped with a closure including a second living hinge in position A according to FIG. 1. The wall thickness of said lunch box is 1.54 mm, and the first and second living hinges have a thickness of 0.30 mm. The mould is equipped with a single point gate and yields the boxes in an open position, allowing testing of the first living hinge connecting the halves in an un-deformed state. An Engel ES 1350/350 HL injection moulding machine was used for production, setting a melt temperature of 260° C., a mould temperature of 25° C. and a filling velocity of 119 cm³/s. This gave a filling time of approximately 1 s, followed by a holding time of 5 s with a holding pressure of 493 bar, and a cooling time before ejection of 12 s. The lunch boxes were stored in open position at 23° C. for at least 96 h prior to testing.

### Top Load Test

For this test, five of the lunch boxes per material were closed and the closure snapped in. Compression test according to DIN 55526-1991 was performed on each box with attest speed of 10 mm/min up to a deformation of 20 mm. The maximum compression force and the deformation at maximum were recorded and the average of the five results calculated.

### Hinge Strength Test

For this test, specimens for an adapted tensile test were cut from the first living hinge side of five lunch boxes per material. The specimens were first cut to a width of 11 mm with a band saw parallel to the A-A′ cross section plane in the central part of the hinge, leaving a 10 mm long plane part of full wall thickness on both sides for clamping. To avoid edge disturbance, the specimens were then trimmed by cutting and milling to a width of 10 mm. The resulting specimens were subjected to a normal tensile test according to ISO 527-1 on a Zwick Z100-725333 machine, using a strain rate of 1 mm/min and testing up to the breakage of the specimen. The stress and extension resp. strain at break were recorded and the average of the five results calculated.

TABLE 3
Lunch box properties

| | |
|---|---|
| Top load test | Hinge strength test |

| | Fmax | Smax | StrB | ExtB | Fmax*StrB |
|---|---|---|---|---|---|
| | [N] | [mm] | [MPa] | [%] | [N*MPa] |
| IE1 | 4052 | 17.8 | 24.8 | 98.6 | 100653 |
| CE1 | 5445 | 18.0 | 14.8 | 49.1 | 80799 |
| CE2 | 3960 | 18.2 | 17.5 | 60.7 | 69423 |
| CE3 | 3053 | 14.7 | 24.7 | 130.9 | 75409 |

Experience shows that the stress and strain at break in a tensile test of a living hinge are proportional to the long-term stability of said hinge, i.e. the number of time which the hinge can be flexed without damage or break. The data of Table 3 consequently show the improved property balance between top load and hinge stability for the inventive example over all of the comparative examples. This good performance is combined with low haze and very low xylene solubles content, as can be seen from the data in Table 2.

1. A living hinge consisting of a polypropylene composition comprising:
(a) at least 95.0 wt. %, based on the total weight of the polypropylene composition, of a propylene copolymer, said propylene copolymer has a comonomer selected from the group consisting of 1-butene, 1-hexene and 1-octene, and
(b) 0.01 to 1.0 wt. %, based on the total weight of the polypropylene composition, of an alpha-nucleating agent,
wherein further the polypropylene composition has:
(i) a comonomer content, measured by ¹³C-NMR, in the range of 2.0 to 6.5 mol %, the comonomer is selected from the group consisting of 1-butene, 1-hexene and 1-octene,
(ii) 2,1 erythro regio-defects, measured by ¹³C NMR, in the range of >0.35 to 0.85 mol %, and
(iii) a melt flow rate MFR₂ (230° C.; 2.16 kg), measured according to ISO 1133, in the range of 15 to 100 g/10 min.

2. The living hinge according to claim 1, wherein the polypropylene composition has a molecular weight distribution (MWD) determined by Gel Permeation Chromatography (GPC) in the range of 2.2 to 3.5.

3. The living hinge according to claim 1, wherein the polypropylene composition is monophasic and optionally has a xylene cold soluble (XCS) fraction, determined at 25° C. according to ISO 16152, in the range of 0.1 to 1.0 wt. %.

4. The living hinge according to claim 1, wherein the polypropylene composition:
(a) has a highest melting peak temperature Tp,m measured by DSC (scan rate of 10° C./min; second heating step) in the range of 140 to 152° C., and
(b) complies with the equation 1:
$$24 ° C . < Tp , m - Tp , c < 32 ° C . \qquad ( 1 )$$
wherein
“T_{p,m}” is the highest melting peak temperature T_{p,m} [° C.] measured by DSC (scan rate of 10° C./min; second heating step) of the polypropylene composition and
“T_{p,c}” is the highest crystallization peak temperature T_{p,c} [° C.] measured by DSC (scan rate of 10° C./min, cooling step) of the polypropylene composition.

5. The living hinge according to claim 1, wherein the propylene copolymer has:
(a) a comonomer content, measured by ¹³C-NMR, in the range of 2.0 to 6.5 mol %, and
(b) 2,1 erythro regio-defects in the range of >0.35 to 0.85 mol %, measured by ¹³C NMR.

6. The living hinge according to claim 1, wherein the propylene copolymer comprises:
(a) a first propylene copolymer fraction (F1) having a comonomer content, measured by ¹³C-NMR, in the range of 2.0 to 6.5 mol %, and
(b) a second propylene copolymer fraction (F2),
wherein
the comonomer for the first propylene copolymer fraction (F1) and the second propylene copolymer (F2) is the same, but the amount of comonomer in the first propylene copolymer (F1) and second propylene copolymer (F2) is different;
the weight ratio between the first propylene copolymer fraction (F1) and the second propylene copolymer fraction (F2) [(F1)/(F2)] is in the range of 60/40 to 40/60, and
the total amount of the first propylene copolymer fraction (F1) and the second propylene copolymer fraction (F2) together, based on the propylene copolymer, is at least 98 wt. %.

7. The living hinge according to claim 6, wherein the propylene copolymer complies with the equation 2:
$$\frac{C ( PPC )}{( C ( F 1 ) \times ⌈ ( F 1 ) / ( PPC ) ⌉ )} > 2.5$$
wherein
“C(PPC)” is the comonomer content [mol %], measured by ¹³C NMR, of the propylene copolymer;
“C(F1)” is the comonomer content [mol %], measured by ¹³C NMR, of the first propylene copolymer fraction (F1);
“(F1)/(PPC)” is the amount of the first propylene copolymer fraction (F1) in the propylene copolymer divided by the amount of the propylene copolymer,
and optionally
the comonomer content between the first propylene copolymer fraction (F1) and the second propylene copolymer fraction (F2) differs in the range of 1.0 to 2.5 mol %.

8. The living hinge according to claim 1, wherein the polypropylene composition comprises further one or more propylene homopolymer(s), wherein the total amount of the one or more propylene homopolymer(s), based on the total amount of the polypropylene composition, is in the range of 0.5 to 3.0 wt. %.

9. The living hinge according to claim 1, wherein the alpha-nucleating agent is selected from the group consisting of polymeric nucleating agent, sorbitol-based nucleating agent, nonitol-based nucleating agent and/or benzene-trisamide-based nucleating agent.

10. The living hinge according to claim 1, wherein the living hinge is obtained by injection molding the polypropylene composition and said living hinge has a thickness in the range of 0.05 to 0.50 mm.

11. An injection molded article comprising two rigid pieces which are connected by one or more living hinge(s), wherein, the injection molded article consists of the polypropylene composition as defined in claim 1, and the injection molded article is made as a single piece, wherein further the one or more living hinge(s) has/have a wall thickness in the range of 0.05 to 0.50 mm.

12. The injection molded article according to claim 11, being a thin wall injection molded article, wherein the thin wall injection molded article has a wall thickness in the range of 0.05 to 2.00 mm.

13. The injection molded article according to claim 11, wherein the two rigid pieces are compartments which are connected by one or more living hinge(s), wherein the two compartments have a wall thickness in the range of 0.06 to 2.00 mm and the one or more living hinge(s) have/has a wall thickness in the range of 0.05 to 0.50 mm.

14. The injection molded article according to claim 11, being a hinge cap, wherein one rigid piece is the cap and the other rigid piece is the mount.

15. (canceled)

16. The living hinge according to claim 8, wherein the further one or more propylene homopolymer(s) have a melt flow rate MFR₂ (230° C.; 2.16 kg), measured according to ISO 1133, in the range of 1.0 to 25.0 g/10 min.

17. A living hinge according to claim 16, wherein the further one or more propylene homopolymer(s) have a highest melting peak temperature T_{p,m} measured by DSC (scan rate of 10° C./min; second heating step) in the range of 162 to 169° C.
